(19) United States
(12) Patent Application Publication
(10) Pub. No.: US 2026/0221522 A1
(43) Pub. Date: Jul. 30, 2026

(54) ALKALINE SECONDARY BATTERY

(71) Applicant: FDK CORPORATION, Tokyo (JP)

(72) Inventors: Takeshi Kajiwara, Tokyo (JP); Tomomichi Yamaguchi, Tokyo (JP); Satoshi Murase, Tokyo (JP); Taketoshi Banno, Tokyo (JP); Takeshi Ito, Tokyo (JP)

(21) Appl. No.: 19/457,261

(22) Filed: Jan. 23, 2026

(30) Foreign Application Priority Data
Jan. 24, 2025 (JP) 2025-010459

(51) Int. Cl. H01M 10/26; H01M 4/36; H01M 4/38; H01M 4/48; H01M 4/52

(52) U.S. Cl. CPC H01M 10/26; H01M 4/364; H01M 4/366; H01M 4/38; H01M 4/48; H01M 4/52; H01M 2300/0014

(57) ABSTRACT

An alkaline secondary battery of the present invention includes a positive electrode, a negative electrode, and an electrolyte. The negative electrode contains a zinc compound and an oxalate or a hydrate thereof. The electrolyte is a solution containing at least one member selected from the group consisting of potassium hydroxide, sodium hydroxide, and lithium hydroxide, and when a concentration of the potassium hydroxide in the electrolyte is A (mol/L), a concentration of the sodium hydroxide in the electrolyte is B (mol/L), and a concentration of the lithium hydroxide in the electrolyte is C (mol/L), expressions (1) and (2) below are satisfied: Expression (1): 8.5≤A+B≤9.5, Expression (2): C/(A+B)≤0.07.

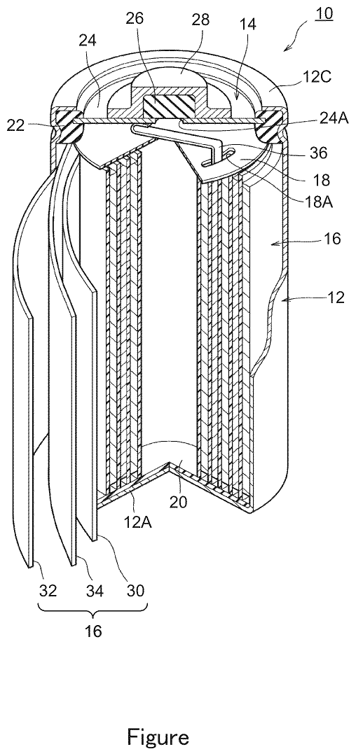

### CROSS REFERENCE TO RELATED APPLICATIONS

This application is entitled to or claims the benefit of Japanese Patent Application No. 2025-010459, filed on Jan. 24, 2025, the disclosure of which including the specification, drawings and abstract is incorporated herein by reference in its entirety.

### TECHNICAL FIELD

The present invention relates to an alkaline secondary battery.

### BACKGROUND ART

As an alkaline secondary battery using zinc, a zinc alloy, or a zinc compound as a negative electrode active material, a nickel-zinc secondary battery, an air-zinc secondary battery, a silver-zinc secondary battery, and the like are known. For example, a nickel-zinc secondary battery is a battery in which a hydrogen storage alloy negative electrode of a nickel-metal hydride secondary battery is replaced with a negative electrode containing zinc or a zinc compound. Zinc is a material which is rich in resources, inexpensive, and has a small environmental load. A nickel-zinc secondary battery also has advantages such as a high open circuit voltage of 1.8 V, a high theoretical energy density, and high output. Because of these characteristics, nickel-zinc secondary batteries have recently been developed as a replacement for lead batteries for power storage applications (for example, uninterruptible power supplies (UPS)) and automotive applications (for example, hybrid vehicles).

On the other hand, in a nickel-zinc secondary battery, zinc in the negative electrode is dissolved in an alkaline aqueous solution as a zincate ion during discharge, and the zincate ion is precipitated as a dendrite on the negative electrode surface during charging, so that short-circuiting is more likely to occur. In addition, repeated dissolution and re-precipitation of zinc in the negative electrode can easily cause morphological changes in the negative electrode, resulting in a short cycle life.

For such problems, various attempts have been made to improve the cycle life. For example, PTL 1 and PTL 2 propose a nickel-zinc secondary battery in which a carboxylate or a carboxylic acid is contained in an electrolyte (see PTL 1 and PTL 2). PTL 3 discloses a nickel-zinc secondary battery containing a high concentration of an alkaline electrolyte substance by containing a borate and a phosphate in an electrolyte.

### CITATION LIST

### Patent Literature

### PLT 1

Japanese Patent Application Laid-Open No. 2021-77594

### PLT 2

Japanese Patent Application Laid-Open No. 2021-158028

### PLT 3

Japanese Patent Application Laid-Open No. 2007-214125

### SUMMARY OF INVENTION

### Technical Problem

Nickel-zinc secondary batteries used for, for example, power storage or automotive applications are sometimes required to be able to discharge at a large current. In particular, batteries are required to be able to discharge at a large current after being used for a long period of time or after being left in a charged state for a long period of time (satisfactory high-rate discharge characteristics).

However, according to the studies of the present inventors, the batteries of PTLS 1 to 3 cannot sufficiently improve the discharge characteristics at a high rate.

The present invention has been made in view of the above circumstances, and an object of the present invention is to provide an alkaline secondary battery having satisfactory discharge characteristics at a high rate even after being used for a long period of time or even after being left in a charged state for a long period of time.

### Solution to Problem

The present invention relates to the following alkaline secondary batteries.

[1] An alkaline secondary battery, including a positive electrode, a negative electrode, and an electrolyte, in which
the negative electrode contains at least one member selected from the group consisting of zinc, a zinc alloy, and a zinc compound, and an oxalate or a hydrate thereof; the electrolyte is a solution containing at least one member selected from the group consisting of potassium hydroxide, sodium hydroxide, and lithium hydroxide; and when a concentration of the potassium hydroxide in the electrolyte is A (mol/L), a concentration of the sodium hydroxide in the electrolyte is B (mol/L), and a concentration of the lithium hydroxide in the electrolyte is C (mol/L), expressions (1) and (2) below are satisfied:

$$8.5 \leq A + B \leq 9 \text{.5} \qquad Expression ( 1 )$$

$$C / ( A + B ) \leq 0.07 . \qquad Expression ( 2 )$$

[2] The alkaline secondary battery according to [1], in which
the electrolyte contains the potassium hydroxide and the sodium hydroxide.

[3] The alkaline secondary battery according to [1] or [2], in which
the positive electrode contains a composite particle including a base particle and a coating layer, the base particle containing nickel hydroxide, the coating layer covering a surface of the base particle and containing a cobalt compound doped with sodium.

### Advantageous Effects of Invention

According to the present invention, it is possible to provide an alkaline secondary battery having satisfactory discharge characteristics at a high rate even after being used for a long period of time or even after being left in a charged state for a long period of time.

### BRIEF DESCRIPTION OF DRAWINGS

The FIGURE is a partially cutaway perspective view of a nickel-zinc secondary battery according to an embodiment of the present embodiment.

### DESCRIPTION OF EMBODIMENTS

As described above, in a conventional alkaline secondary battery using a zinc negative electrode containing zinc, a zinc alloy, or a zinc compound as a negative electrode active material, the discharge characteristics at a high rate are low. The reason for this is not clear, but it is considered as follows.

The reaction of the zinc negative electrode in an electrolyte is represented by the following chemical equations.

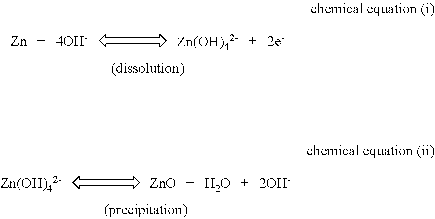

During discharge, the reaction proceeds from left to right. Therefore, in the vicinity of the negative electrode, zinc in the negative electrode is dissolved as a zincate ion, and hydroxide ions are consumed (see chemical equation (i)). Subsequently, the zincate ion is precipitated as zinc oxide and water is generated (see chemical equation (ii)).

That is, factors that cause the reduction of the discharge characteristics at a high rate include: 1) an increase in internal resistance due to the depletion of the electrolyte caused by swelling of the electrode material, the generation of zinc hydroxide, and/or the like, 2) an increase in reaction resistance due to the precipitation and coating of the negative electrode surface with non-conductive zinc oxide, and 3) an increase in diffusion resistance due to a shortage of hydroxide ions in the vicinity of the electrode. According to the studies of the present inventors, it has been found that factors 2) and 3) are dominant factors that reduce the discharge characteristics at a high rate.

The present inventors have found that, when a negative electrode contains an oxalate or a hydrate thereof, and when the electrolyte satisfies expressions (1) and (2) with the concentration of potassium hydroxide as A (mol/L), the concentration of sodium hydroxide as B (mol/L), and the concentration of lithium hydroxide as C (mol/L) in the electrolyte, the resistance components of 2) and 3) can be reduced and the discharge characteristics at a high rate can be improved.

$$8.5 \leq A + B \leq 9 \text{.5} \qquad Expression ( 1 )$$

$$C / ( A + B ) \leq 0 \text{.07} \qquad Expression ( 2 )$$

The mechanism for the finding is not clear, but it is considered as follows. Suppression of increase in reaction resistance of factor 2)

Zinc oxide, namely a discharge product, has a wurtzite structure and usually exhibits donor-type semiconductor characteristics due to oxygen vacancies or the presence of interstitial zinc. When a III group element (for example, a trivalent element such as aluminum or gallium) in the periodic table is used for doping as a donor-type element, the conductivity is improved, but when a monovalent acceptor-type element is used for doping, the conductivity is more likely to be reduced. Lithium is a monovalent acceptor-type element, and has an ion size (effective ionic radius) equivalent to that of zinc, so that it is more likely to cause element substitution, making zinc oxide non-conductive.

On the other hand, in the present invention, by satisfying expression (2), the concentration of lithium ions in the electrolyte can be reduced. As a result, the non-conductivity of zinc oxide due to the element substitution as described above can be suppressed, and the increase in reaction resistance can be suppressed.

### Suppression of Increase in Diffusion Resistance of Factor 3)

The higher the concentration of alkali metal hydroxide ions in the electrolyte, the higher the hydroxide ion concentration, but the higher the viscosity. Therefore, for example, in the case of a potassium hydroxide aqueous solution, the ion conductivity is maximized at a concentration in the vicinity of 7 mol/L. Therefore, (A+B) in the electrolyte is generally set to be in the vicinity of 7 mol/L at which the ion conductivity is maximized.

The present inventors have found that, by further increasing the concentration of the alkali metal hydroxide to be higher than the above-described concentration, specifically, by setting (A+B) to 8.5 mol/L or more, it is possible to suppress the shortage of hydroxide ions even in the case of being discharged at a high rate.

On the other hand, the higher the concentration of the alkali metal hydroxide, the more easily the reaction of chemical equation (i) proceeds and the more easily the zincate ions are stabilized. As a result, the reaction of chemical equation (ii) is less likely to proceed, and a large amount of hydroxide ions are consumed, so that the shortage of hydroxide ions on the negative electrode surface cannot be sufficiently suppressed.

Therefore, in the present invention, (A+B) is further set to 9.5 mol/L or less, and an oxalate or a hydrate thereof is contained in the negative electrode. It is considered that, by containing an oxalate or a hydrate thereof in the negative electrode, the oxalate or the like dissolved in the electrolyte is dissociated into oxalate ions and forms a poorly soluble salt with the zinc element in the negative electrode, so that the solubility of the zincate ions can be reduced. As a result, the reaction can easily proceed from chemical equation (i) to chemical equation (ii) without being stabilized in a state of the zincate ion. As a result, the hydroxide ions are less likely to be consumed in the vicinity of the negative electrode surface, and the shortage of hydroxide ions can be sufficiently suppressed.

That is, by containing an oxalate or a hydrate thereof in the negative electrode and satisfying expression (1), the concentration of hydroxide ions in the vicinity of the negative electrode surface can be maintained high, and the increase in diffusion resistance can be suppressed.

An alkaline secondary battery according to an embodiment of the present invention will be described. In the present embodiment, a nickel-zinc secondary battery will be described as an example of the alkaline secondary battery. However, the present invention is not limited to the embodiment. In addition, in the present specification, a numerical range represented by using “to” means a range including numerical values before and after “to” as the lower limit value and the upper limit value.

### 1. Alkaline Secondary Battery

The FIGURE is a partially cutaway perspective view of nickel-zinc secondary battery 10 of the present embodiment. The FIGURE partly omits the illustration of wound body 16. Nickel-zinc secondary battery 10 of the present embodiment may be in a state before or after activation treatment.

As illustrated in the FIGURE, nickel-zinc secondary battery 10 is, for example, a cylindrical battery of an FA size, and includes outer can 12, sealing body 14, wound body 16 (electrode group), an electrolyte (not illustrated), upper insulation member 18, and lower insulation member 20.

Outer can 12 is a container for housing wound body 16. In the present embodiment, outer can 12 is a bottomed cylindrical container having an open upper end. Outer can 12 is conductive, and bottom wall 12A thereof functions as a negative electrode terminal. The material of outer can 12 may be any material as long as it is conductive and has corrosion resistance against the electrolyte and an electrochemical reaction in the battery, and usually includes a metal material such as iron and steel.

Sealing body 14 is fixed to the opening of outer can 12 via insulation packing 22, and seals outer can 12 and functions as a positive electrode terminal. Sealing body 14 includes lid plate 24, valve body 26, and positive electrode terminal 28.

Lid plate 24 is a conductive member having a disk shape and includes through-hole 24A at the center thereof. Insulation packing 22 has a ring shape surrounding lid plate 24, and is interposed between outer can 12 and sealing body 14. Lid plate 24 and insulation packing 22 cooperate with each other to hermetically close the opening of outer can 12.

Valve body 26 is a member made of rubber, and is disposed on the outer surface of lid plate 24 to block through-hole 24A.

Positive electrode terminal 28 is a member having a cylindrical shape with a metal flange, and is electrically connected to an outer surface of lid plate 24. Positive electrode terminal 28 presses valve body 26 toward lid plate 24. In addition, the positive electrode terminal 28 includes a gas vent hole (not illustrated).

Further, in the normal operation, through-hole 24A is hermetically closed by valve body 26. When gas is generated within outer can 12 and the inner pressure thereof increases, on the other hand, valve body 26 is compressed by the inner pressure to open through-hole 24A, and as a result, gas is released to the outside from the inside of outer can 12 through through-hole 24A and the gas vent hole (not illustrated) of positive electrode terminal 28. That is, through-hole 24A, valve body 26, and positive electrode terminal 28 form a safety valve for a battery.

Wound body 16 includes positive electrode 30, negative electrode 32, and separator 34. That is, wound body 16 is obtained by winding a stack of separator 34, positive electrode 30, separator 34, and negative electrode 32, with negative electrode 32 positioned on the outer side.

Negative electrode 32 is disposed on the outermost peripheral surface of wound body 16 and is in contact with the inner wall surface of outer can 12. That is, negative electrode 32 and outer can 12, serving as a negative electrode terminal, are electrically connected to each other.

Meanwhile, positive electrode lead 36 is connected to positive electrode 30 of wound body 16. Positive electrode lead 36 is connected to lid plate 24. Positive electrode 30 and positive electrode terminal 28 are thus electrically connected to each other via positive electrode lead 36 and lid plate 24.

Upper insulation member 18 is disposed between wound body 16 and lid plate 24. As a result, negative electrode 32 of wound body 16 does not contact sealing body 14. In addition, upper insulation member 18 includes slit 18A for allowing positive electrode lead 36 to pass therethrough.

Lower insulation member 20 is disposed between wound body 16 and the bottom of outer can 12. Positive electrode 30 of wound body 16 thus does not contact the bottom of outer can 12.

An electrolyte (not illustrated) is sealed in outer can 12. The electrolyte is obtained by dissolving at least one member selected from the group consisting of potassium hydroxide, sodium hydroxide, and lithium hydroxide in a solvent such as water. That is, the electrolyte is a solution containing at least one member selected from the group consisting of potassium hydroxide, sodium hydroxide, and lithium hydroxide. When the concentration of the potassium hydroxide in the electrolyte is A (mol/L), the concentration of the sodium hydroxide in the electrolyte is B (mol/L), and the concentration of the lithium hydroxide in the electrolyte is C (mol/L), the electrolyte satisfies expressions (1) and (2).

$$8.5 \leq A + B \leq 9 \text{.5} \qquad Expression ( 1 )$$

$$C / ( A + B ) \leq 0 \text{.07} \qquad Expression ( 2 )$$

When (A+B) is 8.5 mol/L or more, the concentration of hydroxide ions in the vicinity of the negative electrode surface can be increased, so that the increase in diffusion resistance due to the shortage of hydroxide ions can be suppressed. On the other hand, when (A+B) is 9.5 mol/L or less, the viscosity of the electrolyte is less likely to increase, the concentration of hydroxide ions is less likely to decrease due to the progress of the reaction of chemical equation (i), and the increase in diffusion resistance can be suppressed.

In addition, when C/(A+B) is 0.07 or less, the concentration of lithium ions in the electrolyte is low. Therefore, in zinc oxide, namely a discharge product, the non-conductivity of zinc oxide due to the element substitution between zinc and lithium can be suppressed, and the increase in reaction resistance can be suppressed. The lower limit value of C/(A+B) is not particularly limited, but may be 0. That is, C/(A+B) is 0 or more and 0.07 or less.

The concentration of the alkali hydroxide in the electrolyte can be measured by inductively coupled plasma atomic emission spectroscopy (ICP-AES).

The composition of the electrolyte is not particularly limited as long as expressions (1) and (2) are satisfied. In particular, it is preferable that the electrolyte contains potassium hydroxide and sodium hydroxide. By containing potassium hydroxide in the electrolyte, the ion conductivity can be satisfactorily improved. In addition, by further containing sodium hydroxide in the electrolyte, the hydrogen overpotential can be further increased, and the self-discharge reaction—a reaction in which the metal zinc generated during charging is dissolved in the electrolyte while generating hydrogen gas—can be further suppressed. In addition, the decrease in the discharge voltage after long-term storage can be further limited.

When the electrolyte contains potassium hydroxide and sodium hydroxide, the concentration of the sodium hydroxide in the electrolyte is preferably lower than the concentration of the potassium hydroxide. Specifically, a ratio B/(A+B) of the concentration of sodium hydroxide to the sum of the concentrations of potassium hydroxide and sodium hydroxide in the electrolyte is not particularly limited, but is, for example, preferably 0.1 or more and 0.3 or less. When B/(A+B) is 0.1 or more, the self-discharge reaction and the decrease in the discharge voltage after long-term storage can be further reduced. When B/(A+B) is 0.3 or less, the ion conductivity of the electrolyte can be further improved.

Further, a zinc compound such as zinc oxide or zinc hydroxide may be further dissolved in the electrolyte. The above dissolution is for the purpose of further suppressing the elution of zinc or zinc oxide into the electrolyte from the negative electrode. For example, the electrolyte preferably contains zinc oxide dissolved to a saturation concentration. That is, the concentration of zinc ions in the alkaline electrolyte is preferably 4% by mass or more in terms of zinc oxide. The concentration of zinc ions in the alkaline electrolyte can be measured by high-frequency inductivity coupled plasma optical emission spectroscopy (ICP).

As described above, in the nickel-zinc secondary battery including the electrolyte satisfying expressions (1) and (2), it is desired to further suppress the self-discharge reaction. On the other hand, as will be described below, by using composite particles including base particles containing nickel hydroxide and a coating layer containing a cobalt compound doped with sodium as a positive electrode active material, the oxygen overpotential can be further increased, and the self-discharge reaction in the positive electrode can be further suppressed. In addition, by adding a negative electrode additive such as bismuth oxide or indium oxide to the negative electrode, the hydrogen overpotential can be further increased, and the self-discharge reaction in the negative electrode can be further suppressed.

In the following, each member in wound body 16 will be described.

### (1) Positive Electrode

Positive electrode 30 includes a positive electrode mixture and may further include a positive electrode current collector that holds the positive electrode mixture as necessary. In the present embodiment, positive electrode 30 includes a positive electrode current collector and a positive electrode mixture.

### (1.1) Positive Electrode Current Collector

The positive electrode current collector may be, for example, a metal foil, a metal porous body that is mesh-shaped, sponge-shaped, fibrous, or felt-shaped, a punched metal, an expanded metal, or the like. The material of the positive electrode current collector may be a metal material that is stable even at the reaction potential of the positive electrode, for example, nickel or stainless steel, and is preferably nickel. That is, the positive electrode current collector may be foamed nickel or a mesh-shaped, sponge-shaped, fibrous metal body made of nickel or subjected to nickel plating.

### (1.2) Positive Electrode Mixture

The positive electrode mixture contains a positive electrode active material.

### (Positive Electrode Active Material)

Examples of the positive electrode active material include nickel hydroxide. The form of nickel hydroxide is not particularly limited, but has, for example, a powder form (an aggregate of particles containing nickel hydroxide). At least one of cobalt (Co), zinc (Zn), and cadmium (Cd) may be solid solubilized in the particles containing nickel hydroxide. The amount of the solid-solubilized metal element in the particles including nickel hydroxide can be 5% to 10% by mass based on the total mass of the particles.

In addition, the particle containing nickel hydroxide may be a composite particle including a base particle containing nickel hydroxide and a coating layer containing a cobalt compound doped with sodium. The amount of cobalt (Co) in the composite particles can be 2% to 5% by mass based on the total mass of the composite particles.

The coating layer is disposed to cover at least a part of the surface of the base particles. The coating layer preferably includes a cobalt compound doped with sodium. The cobalt compound is preferably a trivalent or higher-order cobalt compound such as cobalt oxyhydroxide (CoOOH). As described above, the higher-order cobalt compound in which the alkali metal is incorporated into the crystal has high conductivity, and the utilization rate of the positive electrode active material can be further improved. In addition, the oxygen overpotential can be further increased, and the self-discharge reaction in the positive electrode can be further suppressed. As a result, the discharge capacity can be further improved.

The presence or absence of the coating layer can be confirmed by producing a cross-sectional sample of the particles containing nickel hydroxide using a cross section polisher and observing the cross section with a scanning electron microscope (SEM).

The average particle diameter of the particles is not particularly limited, but is, for example, preferably 10 μm or more and 20 μm or less. That is, when the average particle diameter of the particles is within the above-described range, the surface area of the particles is further increased, so that the utilization rate of the positive electrode active material can be further improved. The average particle diameter can be measured by a laser diffraction-type particle size analyzer.

The content of the positive electrode active material in the positive electrode mixture can be, for example, 80% by mass or more, and preferably 90% by mass or more and 99% by mass or less, based on the total mass of the positive electrode mixture. The total mass of the positive electrode mixture means the total mass of the positive electrode mixture in a dried state (the total mass of solid contents of the positive electrode mixture).

### (Additional Components)

The positive electrode mixture may further contain a positive electrode additive and/or a binder as necessary.

Examples of the positive electrode additive include yttrium oxide; cobalt compounds such as cobalt oxide, cobalt metal, and cobalt hydroxide; zinc or zinc compounds such as metal zinc, zinc oxide, and zinc hydroxide; rare earth compounds such as erbium oxide; and niobium oxide. For example, a zinc compound such as zinc oxide or zinc hydroxide may be added for the purpose of suppressing the swelling of the positive electrode mixture. When the positive electrode mixture contains a zinc compound, the content of the zinc compound in the positive electrode mixture can be set to 0.1 to 5 mass % based on the total mass of the positive electrode active material.

The binder has a function of binding a positive electrode active material and a positive electrode additive to each other and of binding the positive electrode active material and the positive electrode additive to a positive electrode current collector. The binder may be a hydrophilic or hydrophobic polymer and examples thereof include hydroxypropyl cellulose, carboxymethyl cellulose (CMC), sodium polyacrylate, and fluorine-based polymers (such as polytetrafluoroethylene (PTFE) and polyvinylidene fluoride (PVdF)).

### (2) Negative Electrode

Negative electrode 32 includes a negative electrode mixture, and may further include a negative electrode current collector that holds the negative electrode mixture as necessary. In the present embodiment, negative electrode 32 includes a negative electrode current collector and a negative electrode mixture.

### (2.1) Negative Electrode Current Collector

The negative electrode current collector may be a non-porous current collector or a porous current collector. The non-porous current collector is a current collector having no holes at least in a portion thereof that holds a negative electrode mixture, and is, for example, a non-porous foil. The porous current collector may be, for example, a mesh-shaped, sponge-shaped, fibrous, or felt-shaped metal porous body, a punched metal, or an expanded metal. The material of the current collector may be any metal material that is conductive and is stable at a reaction potential of the negative electrode. Examples of the material of the current collector include copper, copper alloys (for example, brass), and iron, with copper being preferable.

The surface of the negative electrode current collector may be plated. The metal in the plating film is preferably a metal having a hydrogen overvoltage higher than a metal contained in the main body of the current collector, and more preferably a metal (for example, tin or the like) having a hydrogen overpotential higher than copper.

### (2.2) Negative Electrode Mixture

The negative electrode mixture is held by the negative electrode current collector, and has, for example, a layer shape. The negative electrode mixture contains at least one of zinc, a zinc alloy, and a zinc compound, and an oxalate or a hydrate thereof.

### (Zinc, Zinc Alloy, and Zinc Compound)

At least one of zinc, a zinc alloy, and a zinc compound can be contained as the negative electrode active material. Examples of the metal in the zinc alloy, in addition to zinc, include bismuth, aluminum, and indium. Examples of the zinc compound include zinc oxide (grade one/grade two/grade three), zinc hydroxide, zinc sulfide, tetrahydroxy zinc ion salts, zinc halides, zinc carboxylate compounds (for example, zinc acetate or zinc tartrate), zinc salts (for example, magnesium zincate, calcium zincate, and barium zincate), zinc borate, zinc silicate, zinc aluminate, zinc fluoride, zinc carbonate, zinc hydrogen carbonate, zinc nitrate, and zinc sulfate. Among these, the negative electrode active material preferably contains zinc oxide as a main component. The main component is a component contained in, for example, 50 mass % or more based on the total mass of the negative electrode active material. In addition, the negative electrode active material preferably further contains zinc (metal zinc). The zinc can serve as both a discharge reserve and a conductive material.

The negative electrode active material may have any form, and has, for example, a powder form. When the negative electrode active material has a powder form, the average particle diameter of the negative electrode active material is not particularly limited. For example, in the case of using zinc or a zinc alloy, the average particle diameter is preferably 10 μm or more and 1,000 μm or less, and in the case of using a zinc compound, the average particle diameter is preferably 0.1 μm or more and 100 μm or less. The average particle diameter can be measured by the same method as described above.

The content of the negative electrode active material in the negative electrode mixture can be set to, for example, 75 mass % or more, preferably 85 mass % or more and 95 mass % or less, based on the total mass of the negative electrode mixture.

### (Oxalate or Hydrate Thereof)

Examples of the oxalate or a hydrate thereof include alkali metal salts of oxalic acid or hydrates thereof. Examples of the alkali metal salts include sodium salts and potassium salts. Examples of the oxalate include potassium oxalate and sodium oxalate. Examples of the hydrate of oxalic acid include potassium oxalate monohydrate.

When the oxalate or a hydrate thereof in the negative electrode is dissolved in the electrolyte, the oxalate or the hydrate thereof is dissociated into oxalate ions. As a result, the zinc in the negative electrode reacts to form a poorly soluble salt, so that the solubility of the zincate ion can be reduced. By containing an oxalate or a hydrate thereof in the negative electrode, the above-described reaction is more likely to occur in the vicinity of the negative electrode surface as compared with the case of containing the oxalate or the hydrate thereof in the electrolyte. Therefore, the solubility of the zincate ion is more likely to be reduced, and the reaction of chemical equation (i) can be prevented from excessively proceeding.

The content of the oxalate or the hydrate thereof in the negative electrode mixture can be set to, for example, 0.3 mass % or more and 3 mass % or less, preferably 0.5 mass % or more and 2 mass % or less, based on the total mass of the negative electrode mixture. When the content of the oxalate or the hydrate thereof is 0.3 mass % or more, the solubility of the zincate ion during discharge can be further reduced. As a result, the consumption of hydroxide ions in the vicinity of the negative electrode surface due to the progress of the reaction of chemical equation (i) can be further reduced. When the content of the oxalate or the hydrate thereof is 3 mass % or less, the content of the negative electrode active material can be increased, so that the discharge capacity can be further improved.

### (Additional Components)

The negative electrode mixture may further contain an additional negative electrode additive and/or a binder, other than the oxalate or the hydrate thereof.

The additional negative electrode additives other than an oxalate or a hydrate thereof include components that increase the hydrogen overpotential and makes it difficult to cause self-discharge. Examples of such a component include bismuth oxide, bismuth hydroxide, indium oxide, and indium hydroxide. In addition, a component that reduces the solubility of the zincate ion may be contained as an additional negative electrode additive. Examples of such a component include silicates, oleates, stearates, sulfides, carbonates, and the like. Among these, from the viewpoint of making it difficult to reduce the discharge characteristics at a high rate and making it difficult to cause self-discharge, bismuth oxide and indium oxide are preferable.

When the negative electrode mixture contains an additional negative electrode additive, the content of the additional negative electrode additive in the negative electrode mixture can be set to, for example, 1 mass % or more and 20 mass % or less, preferably 3 mass % or more and 10 mass % or less, based on the total mass of the negative electrode mixture.

The binder has a function of binding a negative electrode active material and a negative electrode additive to each other and further has a function of binding the negative electrode active material, the negative electrode additive, and the like to a negative electrode current collector. Examples of the binder include hydroxypropyl cellulose, carboxymethyl cellulose, polyvinyl alcohol, polyvinylpyrrolidone, polyacrylic acid, sodium polyacrylate, polyimide, polyamideimide, polyamide, styrene-butadiene rubber, polyethylene oxide, polytetrafluoroethylene, polyvinylidene fluoride, perfluoroalkoxy fluororesin, and copolymers of tetrafluoroethylene and hexafluoropropylene. Among them, a styrene-butadiene rubber is preferable from the viewpoint that the rubber has a high binding effect and an alkali resistance.

When the negative electrode mixture contains a binder, the content of the binder can be, for example, 1 mass % or more and 5 mass % or less, preferably 1 mass % or more and 3 mass % or less, based on the total mass of the negative electrode mixture.

### (3) Separator

As described above, separator 34 is disposed between positive electrode 30 and negative electrode 32 (see the FIGURE). Separator 34 may be a nonwoven fabric or a microporous film.

The material of the nonwoven fabric and the microporous film is not limited, and may be a polyolefin such as polyethylene or polypropylene, a polyester such as polyethylene terephthalate or polybutylene terephthalate, polyphenylene sulfide, polyamide, or the like. Among them, a polyolefin is preferable, and polypropylene is more preferable from the viewpoint of mechanical strength and shutdown characteristics.

The nonwoven fabric and the microporous film may each be provided with a hydrophilic functional group by hydrophilization treatment. For example, the nonwoven fabric or the microporous film may be a material provided with sulfonic groups by sulfonation treatment such as immersion in an acid containing a sulfuric acid group, such as sulfuric acid or fuming sulfuric acid. It is thus possible to further facilitate the alkaline electrolyte to wet the nonwoven fabric and the microporous film.

One type or a combination of two or more types of separator 34 may be used. For example, a stack of a nonwoven fabric and a micro-porous film subjected to hydrophilic treatment may be used as separator 34.

### 2. Method of Manufacturing Alkaline Secondary Battery

The alkaline secondary battery can be manufactured by any method. For example, the nickel-zinc secondary battery can be manufactured through 1) a step of providing a positive electrode, a negative electrode, and an electrolyte, and 2) a step of obtaining a nickel-zinc secondary battery using the provided positive electrode, negative electrode, and electrolyte.

### Step 1)

First, the positive electrode, the negative electrode, and the electrolyte are provided.

Positive electrode 30 can be produced, for example, by the following procedure. First, a positive electrode active material, a conductive auxiliary agent, a positive electrode additive, a binder, and water or a solvent are mixed and kneaded to obtain a positive electrode mixture slurry. Next, the obtained positive electrode mixture slurry is applied onto the positive electrode current collector, dried, rolled, and cut into a predetermined size to obtain a positive electrode. Negative electrode 32 can also be obtained in the same manner.

The electrolyte can be obtained, for example, by mixing ion exchange water and at least one or more of potassium hydroxide, sodium hydroxide, or lithium hydroxide so as to satisfy expression (1) and expression (2) described above.

### Step 2)

Next, a nickel-zinc secondary battery is produced using the provided positive electrode and negative electrode.

Specifically, the provided positive electrode 30 and negative electrode 32 are stacked with separator 34 (for example, a stack of a nonwoven fabric and a microporous film) therebetween and wound to produce a wound body. Positive electrode lead 36 is welded to one end of positive electrode 30 in the longitudinal direction of the positive electrode. For example, separator 34, positive electrode 30, separator 34, and negative electrode 32 are stacked in this order and wound along the longitudinal direction so that negative electrode 32 is on the outside, thereby obtaining wound body 16.

After housing obtained wound body 16 in outer can 12 and injecting an electrolyte into outer can 12, the opening portion of outer can 12 is sealed with sealing body 14.

After leaving the obtained battery for a predetermined time, activation treatment is performed by charging the battery under a predetermined condition. The activation condition can be adjusted according to the characteristics of the electrode active materials (positive electrode active material and negative electrode active material). In the present embodiment, for example, the following cycle can be repeated three times: the battery is charged to its nominal capacity at a constant current-constant voltage of 1.9 V, and then discharged to 1.3 V. As a result, the nickel-zinc battery 10 can be obtained.

### 3. Variation

In the above-described embodiment, the cylindrical nickel-zinc secondary battery has been described as an example of the nickel-zinc secondary battery, but the present invention is not limited thereto, and a rectangular or laminate type nickel-zinc secondary battery may be used.

In addition, in the above-described embodiment, the nickel-zinc secondary battery has been described as an example of the alkaline secondary battery, but the present invention is not limited to the above-described embodiment. For example, the alkaline secondary battery may be a zinc-air battery (for example, a zinc-air secondary battery) in which the positive electrode is an air electrode, or may be a silver zinc battery (for example, a silver zinc secondary battery) in which the positive electrode is a silver oxide electrode.

### EXAMPLES

Hereinafter, the present invention will be specifically described by Examples, but the present invention is not limited thereto.

### 1. Production of Battery

### [Production of Battery 1]

### (Synthesis of Nickel Hydroxide Particles)

Nickel hydroxide was synthesized by a reaction crystallization method. Ammonium ions were added to an aqueous solution having been obtained by mixing a predetermined amount of nickel sulfate, zinc sulfate, and a cobalt salt to produce an ammine complex. Thereafter, the ammine complex was reacted with an alkaline aqueous solution such as NaOH in a continuous manner while controlling the pH, ammonium ion concentration, reaction temperature, and the like, to gradually grow crystals. As a result, the development of transition pores was suppressed and spherical high-density nickel hydroxide was obtained. The obtained base particles were added to an aqueous ammonia solution, and a cobalt sulfate aqueous solution was added thereto while adjusting the pH, thereby causing cobalt hydroxide to be precipitated on the surface of the base particles. An aqueous solution of sodium hydroxide was sprayed onto the obtained particles in an oxygen-containing atmosphere, and heat treatment was performed to cause chemical oxidation, thereby converting the precipitated cobalt hydroxide into cobalt oxyhydroxide (a conductive cobalt compound).

As a result, nickel hydroxide particles were obtained—the nickel hydroxide particles having a coating layer containing cobalt oxyhydroxide (into which sodium had been introduced) on the surface of the base particles. The average particle diameter of the nickel hydroxide particles was 10 μm.

### (Production of Positive Electrode)

A positive electrode active material slurry was produced by mixing the following components: 100 parts by mass of nickel hydroxide powder, which is an aggregate of the above-described produced nickel hydroxide particles, 3.5 parts by mass of cobalt hydroxide powder, 0.3 parts by mass of yttrium oxide powder, 1 part by mass of zinc oxide powder, 0.3 parts by mass of niobium oxide powder, 0.3 parts by mass of PTFE, and predetermined amounts of a thickener and water.

Foamed nickel was filled with the positive electrode active material slurry, dried, rolled, and cut into a predetermined size to produce a positive electrode having a capacity of 13.4 mAh/cm² per unit area.

### (Production of Negative Electrode)

A negative electrode mixture slurry was produced by mixing the following components: 100 parts by mass of zinc oxide powder, 25 parts by mass of metal zinc powder, 2 parts by mass of potassium oxalate monohydrate (1.5 mass % based on the total mass of the negative electrode mixture), 2 parts by mass of bismuth oxide powder, and predetermined amounts of a thickener, water, and styrene butadiene rubber.

The negative electrode mixture slurry was applied onto a copper non-porous foil on which tin plating was performed on its surface. The electrode plate was dried, rolled with a rolling roll to increase the density of the active material, and cut into a predetermined size. As a result, a negative electrode having a capacity of 25 mAh/cm² per unit area was produced.

### (Production of Electrolyte)

Potassium hydroxide, sodium hydroxide, and lithium hydroxide were added to ion exchange water to have concentrations of 6.3 mol/L, 2.5 mol/L, and 0.6 mol/L, respectively, thereby preparing a solution. In the solution, 4 mass % of zinc oxide was further dissolved to obtain an electrolyte.

### (Assembly of Battery)

The above-described produced positive electrode and negative electrode were wound together with a separator (in which a nonwoven fabric separator and a dendrite-resistant separator (microporous film) were combined) to obtain an electrode group. Specifically, a stack including the separator, positive electrode, separator, and negative electrode stacked in this order was wound to obtain an electrode group in which the negative electrode was disposed on the outermost peripheral surface. The separator was disposed in such a way that the dendrite-resistant separator was on the negative electrode side. The obtained electrode group was inserted into an outer can subjected to tin plating.

Then, a predetermined amount of the above-described produced electrolyte was injected to produce a cylindrical nickel-zinc battery having a nominal capacity of 2000 mAh.

### (Activation Treatment)

The thus obtained battery was subjected to an activation treatment by repeating a cycle of charging the battery to 100% of the nominal capacity and discharging the battery to 1.3 V three times.

### [Production of Batteries 2 to 7]

Batteries 2 to 7 were produced in the same manner as for the battery 1, except that the composition of the electrolyte was changed as shown in Table 1.

### 2. Evaluation of Battery

Each produced battery was charged at a voltage of 1.84 V for 24 hours in an environment of 25° C. Next, a discharge test was performed for 15 seconds at a constant current corresponding to 9 C in an environment of −5° C., and the discharge voltage at that time was measured.

Thereafter, the battery was subjected to float charging at 1.84 V in an environment of 25° C. for 3 months, and the discharge test was performed once a month to measure the discharge voltage.

When the discharge voltage was 0.9 V or more, it was determined to be satisfactory.

Table 1 shows the measurement results of the batteries 1 to 7.

TABLE 1

| | Example | | | | Comparative example | | |
|---|---|---|---|---|---|---|---|
| Battery No. | 1 | 2 | 3 | 4 | 5 | 6 | 7 |
| Oxalate or hydrate | Present | Present | Present | Present | Present | Present | Present |
| in negative | | | | | | | |
| electrode | | | | | | | |
| KOH [mol/L]: A | 6.3 | 6.6 | 6.9 | 9.4 | 6.0 | 7.0 | 5.4 |
| NaOH [mol/L]: B | 2.5 | 2.5 | 2.5 | 0 | 0 | 0 | 0.7 |
| LiOH [mol/L]: C | 0.6 | 0.3 | 0 | 0 | 0.5 | 1.0 | 1.2 |
| A + B [mol/L] | 8.8 | 9.1 | 9.4 | 9.4 | 6.0 | 7.0 | 6.1 |
| C/(A + B) | 0.07 | 0.03 | 0 | 0 | 0.08 | 0.14 | 0.20 |
| Initial discharge | 1.526 | 1.542 | 1.541 | 1.550 | 1.172 | 1.488 | 1.204 |
| voltage [V] | | | | | | | |
| Discharge voltage | 1.484 | 1.500 | 1.512 | 1.501 | Not | 1.247 | Not |
| after 1 month [V] | | | | | dischargeable | | dischargeable |
| Discharge voltage | 1.454 | 1.468 | 1.489 | 1.450 | Not | 1.139 | Not |
| after 2 months [V] | | | | | dischargeable | | dischargeable |
| Discharge voltage | 1.429 | 1.457 | 1.485 | 1.455 | Not | 0.933 | Not |
| after 3 months [V] | | | | | dischargeable | | dischargeable |

As shown in Table 1, it was found that batteries 5 to 7, in which the negative electrode contained a hydrate of an oxalate, but (A+B) was lower than 8.5 mol/L and C/(A+B) was higher than 0.07, have a low initial discharge voltage and a low discharge voltage after 1 to 3 months. In particular, batteries 5 and 7, in which (A+B) was as low as 6.0 mol/L or 6.1 mol/L, have a discharge voltage lower than 0.9 V after one month and are no longer able to discharge.

On the other hand, it was found that batteries 1 to 4, in which the negative electrode contained a hydrate of an oxalate, (A+B) was 8.5 to 9.5 mol/L, and C/(A+B) was 0.07 or less, have an initial discharge voltage as high as 1.5 V or more and a discharge voltage as high as 1.4 V or more even after 3 months.

As a result, it was found that the discharge characteristics at a high rate becomes satisfactory by containing an oxalate or a hydrate thereof in a negative electrode, and setting (A+B) to 8.5 to 9.5 mol/L and C/(A+B) to 0.07 or less. The reason for such satisfactory results is considered that the non-conductivity of zinc oxide, namely a discharge product, is suppressed, the increase in reaction resistance is suppressed, and the consumption of hydroxide ions in the vicinity of the negative electrode during discharge is suppressed, and the increase in diffusion resistance is suppressed.

### INDUSTRIAL APPLICABILITY

The present invention can provide an alkaline secondary battery having satisfactory discharge characteristics at a high rate even after being used for a long period of time or even after being left in a charged state for a long period of time.

What is claimed is:

1. An alkaline secondary battery, comprising:
a positive electrode; a negative electrode; and an electrolyte, wherein
the negative electrode contains at least one member selected from the group consisting of zinc, a zinc alloy, and a zinc compound, and an oxalate or a hydrate thereof,
the electrolyte is a solution containing at least one member selected from the group consisting of potassium hydroxide, sodium hydroxide, and lithium hydroxide, and
when a concentration of the potassium hydroxide in the electrolyte is A (mol/L), a concentration of the sodium hydroxide in the electrolyte is B (mol/L), and a concentration of the lithium hydroxide in the electrolyte is C (mol/L), expressions (1) and (2) below are satisfied:
$$8.5 \leq A + B \leq 9 \text{.5} \qquad Expression ( 1 )$$
$$C / ( A + B ) \leq 0.07 . \qquad Expression ( 2 )$$

2. The alkaline secondary battery according to claim 1, wherein
the electrolyte contains the potassium hydroxide and the sodium hydroxide.

3. The alkaline secondary battery according to claim 1, wherein
the positive electrode contains a composite particle including a base particle and a coating layer, the base particle containing nickel hydroxide, the coating layer covering a surface of the base particle and containing a cobalt compound doped with sodium.
